(19) United States
(12) Patent Application Publication
(10) Pub. No.: US 2014/0219058 A1
(43) Pub. Date: Aug. 7, 2014

(54) ULTRASOUND IMAGING TOOL FOR ROCK CORES

(71) Applicants: KING ABDULAZIZ CITY FOR SCIENCE AND TECHNOLOGY, RIYADH (SA); KING FAHD UNIVERSITY OF PETROLEUM AND MINERALS, DHAHRAN (SA)

(72) Inventors: WAIL MOUSA, DHAHRAN (SA); ABDULLATIF ABDULRAHMAN AL-SHUHAIL, DHAHRAN (SA)

(73) Assignees: KING ABDULAZIZ CITY FOR SCIENCE AND TECHNOLOGY, RIYADH (SA); KING FAHD UNIVERSITY OF PETROLEUM AND MINERALS, DHAHRAN (SA)

(21) Appl. No.: 13/758,919

(22) Filed: Feb. 4, 2013

(51) Int. Cl. G01S 15/89

(52) U.S. Cl. CPC G01S 15/89
USPC 367/87

(57) ABSTRACT

The ultrasound imaging tool for rock cores includes an ultrasound generator that can be inserted at selected depths into a drilled bore in a geological core sample. An array of ultrasound receivers are placed completely around the outer surface of the core sample. The ultrasound generator produces the ultrasound waves at various depths inside the bore, and the data obtained by the ultrasound receivers generates a complete 3-D ultrasound image of the core sample.

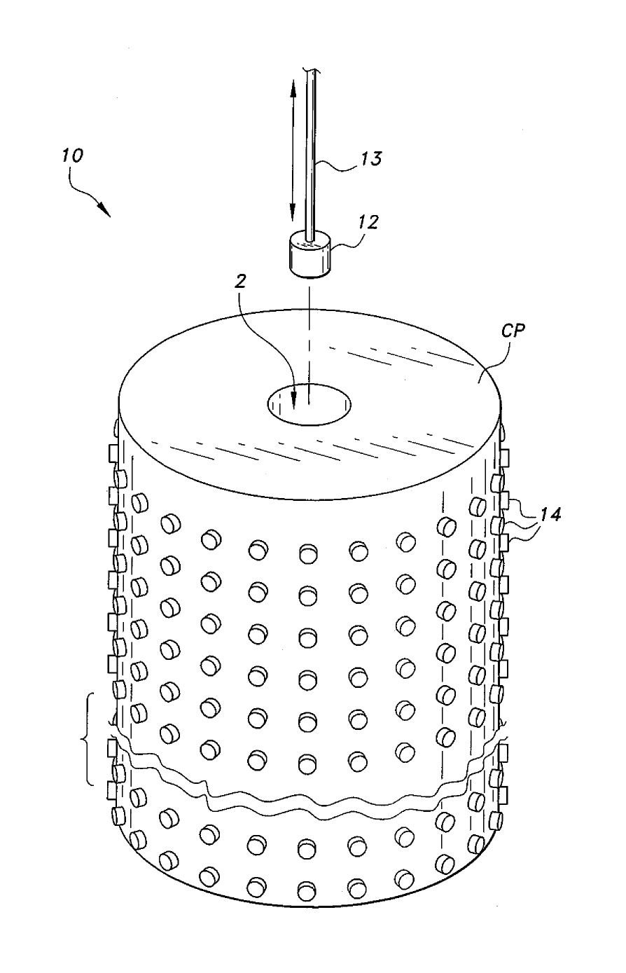

### BACKGROUND OF THE INVENTION

1. Field of the Invention

The present invention relates to geological instrumentation, and particularly to an ultrasound imaging tool for rock cores that obtains and measures data for generating high resolution 3-D image.

2. Description of the Related Art

Geological and petro-physical sectors are becoming more appreciative of the use of signal processing in many of their applications. This appreciation came as a result of the increased demand in oil production from complex carbonate reservoirs, which requires more in-depth analysis of well-log, seismic, and core data. Generally, a large number of cores are acquired from most of the wells, and various data acquisition techniques, such as computed tomography (CT) and magnetic resonance imaging (MRI), have been used to obtain a better understanding of the core structures. Ultrasound technique is another method for obtaining fluid-fill information similar to those used in medical ultrasound diagnosis. On a larger scale, ultrasound borehole imaging is used mainly to identify fractures and vuggy porosity of only borehole surfaces, where the remaining data are not utilized. This is due to the fact that only the ultrasound first breaks are analyzed and processed. In other configurations, the acquisition is done using a zero-offset source-receiver configuration.

There exist many applications that have benefited from ultrasound technologies, such as medical and industrial non-destructive testing (NDT). In the petroleum industry, ultrasound technology is used for several applications, including core characterization, well logging, and borehole surface imaging. The use of ultrasonic waves in characterizing cores is very widely used. For example, it has been used to estimate the relation between the P-wave velocity and water saturation in cores.

This method uses the first P-wave arrival and core length to measure the P-wave velocity in the core. Unfortunately, this application lacks the information that can be provided only by other wave modes and arrivals. Ultrasonic waves are commonly used in well logging using a standard configuration known as the borehole-compensated (BHC) sonic log. This method uses mainly the first P-wave arrival refracted from the borehole wall. Although other modes, including shear and surface waves, might also be used, all of the used modes propagate along the borehole axis. This configuration is not suitable for anisotropic formations, where wave velocity varies with propagation direction. In a recent borehole-surface imaging tool, data acquisition is done using a constant-offset source-receiver configuration using a sampling of a few degrees at each depth level. This technology utilizes only the P-wave reflected off the borehole wall and is mainly used to estimate the borehole size.

In light of the above, it would be a benefit in the diagnostic arts to provide an ultrasound tool that can measure 3-D ultrasound images of rock core samples with acquisition schemes similar to those used in borehole and surface seismic exploration methods, thereby generating a more complete 3-D image. Thus, an ultrasound imaging tool for rock cores solving the aforementioned problems is desired.

### SUMMARY OF THE INVENTION

The ultrasound imaging tool for rock cores includes an ultrasound generator that can be inserted at selected depths into a drilled bore in a geological core sample. An array of ultrasound receivers are placed completely around the outer surface of the core sample. The ultrasound generator produces the ultrasound waves at various depths inside the bore, and the data obtained by the ultrasound receivers generates a complete 3-D image of the core sample.

The ultrasound imaging tool, in comparison to existing ultrasound tools, produces complete 3-D images of the studied rock core based on various wave modes (P, S, and surface) and arrivals (direct, refracted, and reflected). The recorded parameters include travel time and amplitudes of various wave modes and arrivals. The recorded travel times and amplitudes can be inverted for important petrophysical properties, such as porosity, anisotropy, velocity, and attenuation coefficient.

These and other features of the present invention will become readily apparent upon further review of the following specification and drawings.

### BRIEF DESCRIPTION OF THE DRAWINGS

The sole drawing FIGURE is an environmental, perspective view of an ultrasound imaging tool for rock cores according to the present invention.

### DETAILED DESCRIPTION OF THE PREFERRED EMBODIMENTS

The ultrasound imaging tool for rock cores, generally referred to by the reference number 10 in the drawing, includes an ultrasound generator 12 placed above a geological core sample or plug CR The core plug CP is a typical cylindrical sample with the addition of a bore or hole 2 drilled axially therein. It is to be understood that the ultrasound imaging tool 10 can be used on any size or shape core plug. The ultrasound generator 12 is attached to a shaft or arm 13 to facilitate selective lowering and raising of the ultrasound generator 12 into and out of the hole 2. During use, the ultrasound generator 12 is lowered to selected depths within the core plug CP to generate the ultrasound waves for measurement. Selective reciprocation of the ultrasound generator 12 can be accomplished manually, but it is more preferred to utilize automated means, such as servo motors and the like (not shown) for controlled and accurate data acquisition. In this manner, the ultrasound generator 12 can be raised or lowered continuously or incrementally, as required or desired, with a high degree of accuracy. The ultrasound generator 12 can be an ultrasound transducer, a low-impact charge, or the like.

A plurality of ultrasound receivers 14 are attached to the circumferential surface of the core plug CP in a predetermined array. The number and spacing are predetermined to provide the most data for generating the 3-D image. The core plug CP may be, e.g., a standard sample having a 38.1 mm (1.5 inch) diameter and 76.2 mm (3 inch) length. For a core plug CP having these dimensions, the drilled hole may be about 2.1 mm in diameter. The ultrasound receivers may be spaced about 8 mm apart in the circumferential direction, and about 4 mm apart in the axial direction (i.e., downward into the bore 2). This results in fifteen circumferential rows of twenty ultrasound receivers 14 arranged along the axis of the core plug CP, for a total of 300 ultrasound receivers 14. The receivers are preferably connected to the surface of the core plug CP by using an ultrasonic coupling gel. Although not shown, it will be understood that each receiver 14 includes wires attaching the receiver 14 to a data recording device.

In use, the ultrasound generator 12 is lowered to a selected depth within the hole 2 corresponding to a user-selected axial row of ultrasound receivers 14. This process can begin either from the top or bottom of the core plug CP. At the selected depth, the ultrasound generator 12 produces ultrasonic waves to be recorded by the corresponding row of ultrasonic receivers 14. The above steps are repeated for each successive depth and row of receivers. This produces a geometry that is similar to regular 3-D surface seismic surveys, which allows for data processing using available 3-D seismic data processing software. For better source coupling, the hole 2 can be filled with a fluid and the ultrasound generator 12 can be pushed against the hole wall using an appropriate clamp.

The dominant frequency of the source wavelet should be selected large enough to avoid scattering by the background reservoir's sediment grains, typically having sub-millimeter sizes. Preferably, the source dominant frequency generates a wavelength that is greater than the mean grain size of the background sediment. For example, a dominant source frequency of 1 MHz should be selected to analyze a core plug CP with a background carbonate material having a P-wave velocity of 4,000 m/s, which results in a wavelength of 4 mm.

It is preferred that the time sampling interval (dt) for the receivers 14 should satisfy the Nyquist sampling criteria, namely dt=1/(2 X source dominant frequency). For example, if dt=0.5 micro-second, then the source dominant frequency would be 1 MHz. The recommended number of samples should be 1.5-2 times the longest arrival time. For example, 500 samples per trace should be selected in order to catch first arrivals along the longest raypath for most wave modes of interest, i.e., P, S, and surface, assuming typical carbonate reservoir P-wave velocity of 4,000 m/s, S-wave velocity of 2,100 m/s, and surface-wave velocity of 1,900 m/s.

Thus, it can be seen that the ultrasound imaging device 10 for rock cores produces relatively high resolution 3-D images. Instead of just the P-wave, other wave parameters can be analyzed to produce a clearer image of the core sample CP.

It is to be understood that the present invention is not limited to the embodiments described above, but encompasses any and all embodiments within the scope of the following claims.

We claim:

1. An ultrasound imaging tool for rock cores, comprising:
a selectively reciprocating elongated arm;
an ultrasound generator mounted at an end of the arm, the ultrasound generator being configured to produce ultrasonic waves, the arm being adapted for selectively lowering and raising the ultrasound generator into or out of an axial hole drilled into an elongate core plug; and
a plurality of ultrasound receivers adapted for attachment to an outer surface of the core plug, the ultrasound receivers being configured for recording ultrasonic waves generated by the ultrasound generator at predetermined sampling intervals, the ultrasound receivers being adapted for arrangement around the whole outer surface of the core plug in predetermined, spaced rows at predetermined depths along the length of the core plug;
wherein ultrasonic waves generated by the ultrasound generator at successive depths corresponding to the location of each the rows of ultrasound receivers generates a 3-D ultrasound image.

2. The ultrasound imaging tool for rock cores according to claim 1, wherein said ultrasound generator comprises an ultrasound transducer.

3. A method for producing a 3-D ultrasound image for rock cores, comprising the steps of:
providing an elongate core plug having a top, bottom and an axial hole drilled therein;
providing an ultrasound imaging tool for rock cores, the tool having:
a selectively reciprocating arm;
an ultrasound generator mounted at an end of the arm, the ultrasound generator being configured for producing ultrasonic waves, the arm being configured for selectively lowering and raising the ultrasound generator into or out of the axial hole; and
a plurality of ultrasound receivers attached to the outer surface of the core plug, the ultrasound receivers being configured for recording the ultrasonic waves generated by the ultrasound generator at predetermined sampling intervals, the ultrasound receivers being arranged around the whole outer surface of the core plug in predetermined, spaced rows at intervals along the length of the core plug;
placing the ultrasound generator inside the axial hole at a selected depth near an end of the core plug;
generating ultrasound waves by the ultrasound generator;
recording the ultrasound waves by the ultrasound receivers at the selected depth of the ultrasound generator;
moving the ultrasound generator to another depth corresponding to an adjacent row of the ultrasound receivers;
repeating the steps of generating ultrasound waves and recording the ultrasound waves;
repeating the steps of moving the ultrasound generator to another depth, generating ultrasound waves, and recording the ultrasound waves until substantially the whole length of the core plug has been recorded; and
generating a 3-D ultrasound image from the recorded ultrasound waves.
